(19) United States
(12) Patent Application Publication
(10) Pub. No.: US 2013/0030886 A1
(43) Pub. Date: Jan. 31, 2013

(54) METHODS AND APPARATUS TO TRANSLATE MODELS FOR EXECUTION ON A SIMULATION PLATFORM

(71) Applicants: Vincent Edward Poortinga, Arlington Heights, IL (US); Erik Hirschfeld, Frankfurt (DE)

(72) Inventors: Vincent Edward Poortinga, Arlington Heights, IL (US); Erik Hirschfeld, Frankfurt (DE)

(21) Appl. No.: 13/194,917

(22) Filed: Jul. 30, 2011

(51) Int. Cl. G06F 17/10; G06Q 30/02

(52) U.S. Cl. 705/14.4; 703/2

(57) ABSTRACT

Methods and apparatus are disclosed to translate a model. An example method includes applying an independent variable and a dependent variable to the model and estimating a value for a model parameter, generating predicted best fit data points based on the model parameter, values associated with the independent variable, and values associated with the dependent variable, estimating coefficients based on the best fit data points, and generating a spline comprising a plurality of polynomial functions based on the coefficients.

### FIELD OF THE DISCLOSURE

This disclosure relates generally to market research, and, more particularly, to methods and apparatus to translate models for execution on a simulation platform.

### BACKGROUND

In recent years, marketing models have been developed to identify reasons explaining sales volume change. Responses to one or more marketing campaigns may result in a volume change, such as an increase in sales associated with a product and/or service targeted by the campaign(s). Generally speaking, a campaign may include a group of related causals and/or drivers, in which an example driver is a channel of a marketing category. A decomposition of a marketing model is an analysis of marketing drivers (e.g., a channel of a marketing category such as television advertising, print advertising, online advertising, public relations, coupons and/or in-store promotions) and corresponding effects on sales. One or more decompositions of the marketing model may, in some examples, identify a cause for an observed volume change and/or a portion of the observed volume change. Additionally, the identified cause for the volume change may be translated by the marketing model to reveal a corresponding lift, which may represent a transformation of volume (e.g., a percent lift is a volume due-to a causal divided by a base volume, which represents a volume devoid of causal influence).

The cause for the volume change may include one or more campaign components such as television advertisements, in-store promotions, flyers, etc. Each decomposition from the marketing model mathematically represents one or more causal effects. In the event one or more simulations are to be performed using a given model, the model is programmed into a simulator to allow one or more simulations to be executed based on the model.

### BRIEF DESCRIPTION OF THE DRAWINGS

FIG. 1 is a schematic illustration of an example system to perform market simulations for multiple marketing models.

FIG. 2 is a schematic illustration of an example implementation of the model translation engine of the example system of FIG. 1.

FIG. 3 illustrates an example model, which may be input to the example system of FIG. 1.

FIGS. 4, 5A and 5B are example scatter plots generated by the example model translation engine of FIGS. 1 and 2 for the example model of FIG. 3.

FIG. 6 is an example scatter plot fitted with a spline generated by the example model translation engine of FIGS. 1 and 2.

FIG. 7 is a chart of example output(s) generated by the example model translation engine of FIGS. 1 and 2 reflecting the spline for the example model of FIG. 3.

FIG. 8 is a flowchart representative of example machine readable instructions that may be executed to implement the example system of FIG. 1 and/or the example model translation engine of FIGS. 1 and 2.

FIG. 9 illustrates an example processor platform that may execute the instructions of FIG. 8 to implement any or all of the example methods, systems, and/or apparatus disclosed herein.

### DETAILED DESCRIPTION

Methods, apparatus, and articles of manufacture are disclosed, which apply an independent variable and a dependent variable to the model and estimating a value for a model parameter, generate predicted best fit data points based on the model parameter, values associated with the independent variable, and values associated with the dependent variable, estimate coefficients based on the best fit data points, and generate a spline comprising a plurality of polynomial functions based on the coefficients.

Marketing models may be employed to reveal, in part, an indication of a return on investment (ROI) of one or more marketing campaigns. A marketing model typically includes a volumetric decomposition that divides total sales of a product and/or service into components contributed by one or more marketing drivers. As used herein, a driver is a channel of marketing category. Marketing drivers may include, but are not limited to television advertising, print advertising, online advertising, public relations and/or in-store promotions. In some examples, drivers may be grouped into higher level categories such as, but not limited to media, direct-to-consumer, and/or trade. Additionally, a causal may be represented as a value and/or unit of measure for a driver. For example, television may be measured in gross rating points (GRPs), reach (a percent of households over a time period), frequency (number of views reached per household), and/or targeted demographic rating points (TRPs).

While a marketing campaign may include one or more types of casuals and/or drivers (and/or groups thereof) to promote one or more goods and/or services, each causal produces a corresponding “shape” indicative of effectiveness. As used herein, a shape is a metric indicative of a (positive or negative) change in sales, and reflects an analytic function, which translates the causal(s) into expected lift of sales. In other words, each shape identifies a volumetric lift (or decay) of sales for the corresponding causal and one or more products and/or services associated with a marketing campaign and/or other marketing effort in which the causal(s) occur. A shape of a given causal may identify diminishing marginal returns as additional casuals (e.g., media stimuli) are added to the campaign. For example, adding additional television commercials to be viewed by an audience that has already seen the television commercials at a prior time produces a less dramatic behavioral effect on the audience as compared to circumstances where the audience views the television commercial for the first time. In the event that additional GRPs are added to a campaign (e.g., additional advertisements at additional days and/or times), some shapes of some casuals may exhibit a saturation point and/or diminishing marginal returns.

Methods, apparatus, systems and/or articles of manufacture disclosed herein enable a simple simulation platform to simulate the effects of changing one or more aspects of a causal (e.g., one or more campaigns). Marketing planners and/or others chartered with a responsibility to develop and/or otherwise manage one or more marketing drivers may execute one or more “what if” scenarios using one or more model(s) to determine a corresponding effect on market volume/sales. For example, the marketing planners may wish to identify a likely effect on sales in the event a television advertisement component of a marketing driver was increased by 25%, or the price of a product was increased by 30%.

Developing models to illustrate one or more effects typically includes a degree of model developer discretion. As a result, model developers have developed and continue to develop different models, many of which are unique. In the event the marketing planners wish to use a given model to perform one or more simulations, the functional form (e.g., a mathematical representation of that model) of the model must be programmed into a simulator, which typically requires customized code development services. The marketing planners may have confidence in any number of disparate models based on, for example, observed statistical significance, observed consistency with market performance, etc. However, the numerous disparate models often employ different mathematical expressions (e.g., exponentials, negative exponentials, logarithms, s-shaped curves, etc.). Thus, to adopt a given model to a study of interest, it is often necessary to develop customized software (e.g., code). As a result, there is often significant reliance on customized code development services to prepare one or more simulators to perform market simulation activities.

Example methods, systems, apparatus and/or articles of manufacture disclosed herein translate custom models to a consistent and/or normalized format that may be employed by a same simulator to facilitate market simulation activities. As described in further detail below, example methods, systems, apparatus and/or articles of manufacture disclosed herein receive a custom model and corresponding data to be analyzed by the model, mathematically estimate the model to derive values for one or more coefficients that best fit the data, extrapolate model data, and generate a standardized set of coefficients to be used to represent the model on the simulator. A benefit of some example methods, systems, apparatus and/or articles of manufacture disclosed herein is that the simulator may be programmed only one time to receive the standardized set of coefficients rather than the multiple and exhaustive programming efforts typically required in the prior art to prepare the simulator for each unique marketing model.

As described in further detail below, in some disclosed examples splines are employed to abstract any model of interest so that the same simulator and/or simulation software can be used to perform marketing simulations with alternate data (e.g., alternate “what if” scenarios) for each of multiple different models. As such, example methods, systems, apparatus and/or articles of manufacture disclosed herein afford greater flexibility to marketing planners by enabling multiple models (including models developed by third parties) to be used as a basis of simulating market research activities on a same simulation platform.

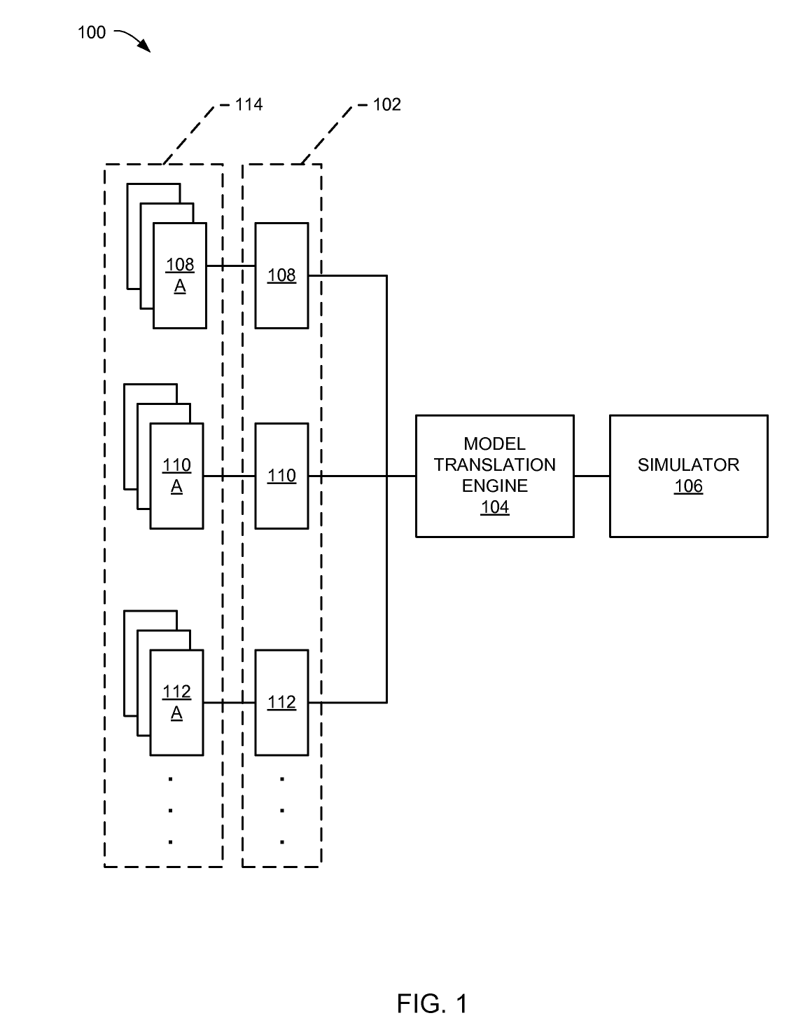

FIG. 1 is a schematic illustration of an example system 100 that receives one or more model(s) 102 and employs a model translation engine 104 to develop a standardized transformation output to be used with a simulator 106. Example model(s) 102 are represented by one or more equations (functional form factors) having one or more parameters. Additionally, the example model(s) 102 typically include one or more independent variables 110 representing one or more causals. As described above, causal data may be indicative of stimuli directed to eliciting behavioral response(s) from consumers, such as television advertisements, newspaper advertisements, flyers and/or in-store promotional activities. The example model(s) 102 typically also include dependent variables 112, which represent the effect(s) caused by (or dependent upon) the independent variable(s).

In operation, example model(s) 102 and supporting data 114 are retrieved and/or otherwise obtained. In the illustrated example, each model 108, 110, 112 is provided with corresponding supporting data 108A, 110A, 112A. The supporting data 108A, 110A, 112A may be formatted as tabular data, matrix data and/or any other data format. While the illustrated example of FIG. 1 includes three models (108, 110, 112), the methods, apparatus, systems and/or articles of manufacture disclosed herein may include any number of models. In some examples, the supporting data 114 includes spreadsheet file(s) having column(s) of independent variable value(s) and rows indicative of corresponding temporal information (e.g., seconds, minutes, hours, days, weeks, months, quarters, years, etc.).

Each of the example model(s) 102 of FIG. 1 includes one or more equations having any number of variables, parameters and/or mathematical function(s). The example model translation engine 104 of FIG. 1 receives and/or otherwise obtains the model(s) 102 and supporting data 114 to build scatter plots of independent variable(s) to dependent variable(s), to find best fit parameters that fit the scatter plot(s), to estimate predicted independent and dependent values beyond an original data range, and/or to estimate a spline comprised of multiple equations using the predicted independent and dependent values. Additionally, the example model translation engine 104 of FIG. 1 develops a standardized output format of coefficients to be used as input for the example simulator 106, as described in further detail below.

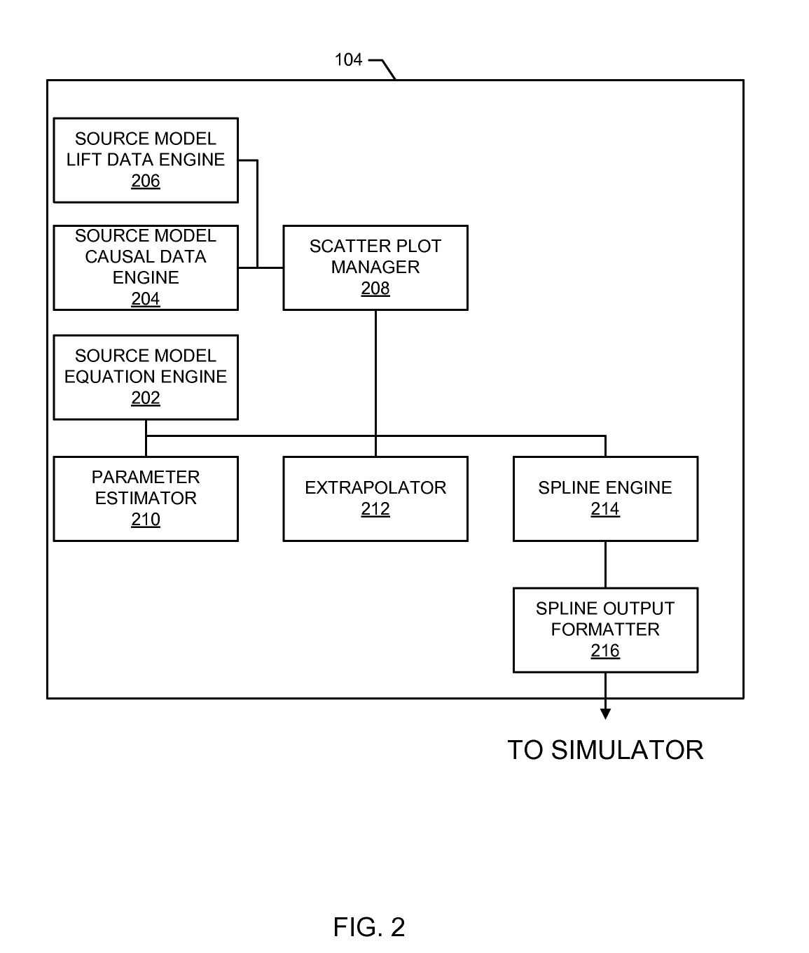

FIG. 2 is a schematic illustration of an example implementation of the example model translation engine 104 of FIG. 1. In the illustrated example of FIG. 2, the model translation engine 104 includes a source model equation engine 202, a source model causal data engine 204, a source model lift data engine 206, a scatter plot manager 208, a parameter estimator 210, an extrapolator 212, a spline engine 214 and a spline output formatter 216. The example source model equation engine 202 of FIG. 2 receives one of the example model(s) 102 (e.g., a functional form of one of the models, 108, 110, 112, etc.) and/or a selection thereof and identifies one or more parameters to be estimated for the model. The example causal data engine 204 and lift data engine 206 of FIG. 2 prepare and/or otherwise reformat the supporting data 114 corresponding to the received and/or otherwise selected model. The example supporting data 114 may include independent variable data and/or dependent variable data, which may be used by the example scatter plot manager 208 to build a scatter plot. In the illustrated example, the causal data engine 204 and lift data engine 206 receives a matrix of source values and translate such source values into corresponding rows and columns of data for later processing. In other examples, the causal data engine 204 and lift data engine 206 parse source text files of supporting data 114 that may contain comma separated data, space separated data and/or any other format of independent and/or dependent variable values.

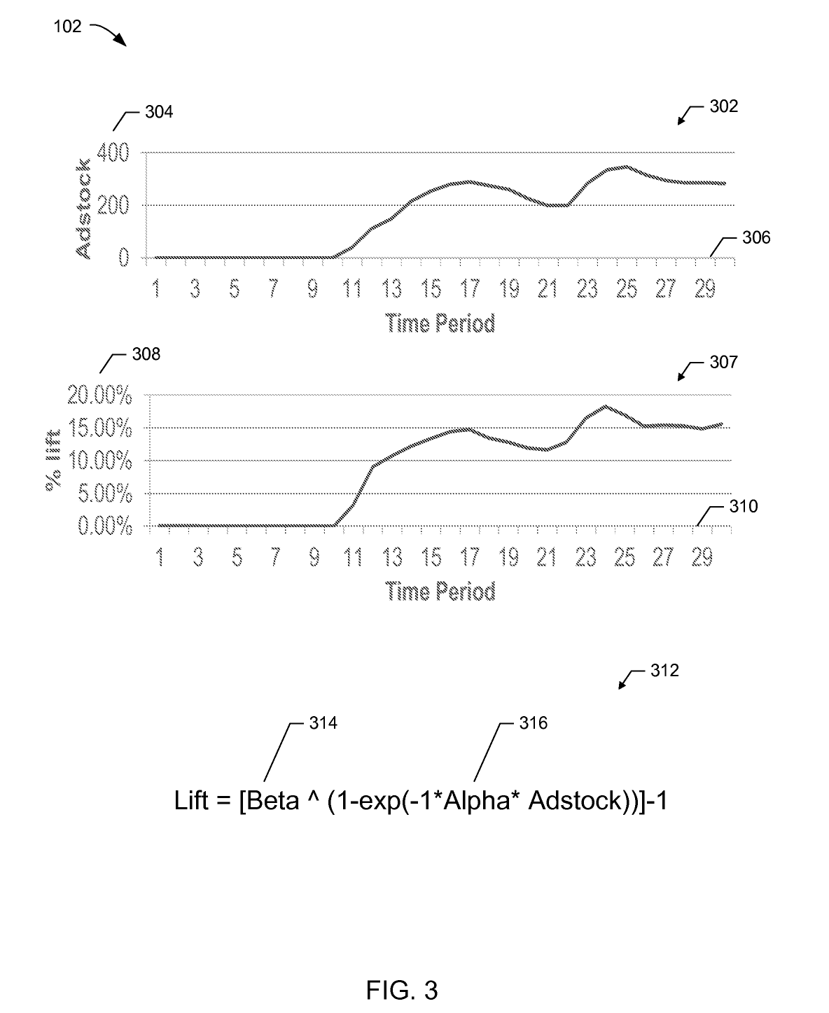

Turning briefly to FIG. 3, an example model 312 and supporting data 302, 307 are shown, which may be processed by example methods, systems, apparatus and/or articles of manufacture disclosed herein. In the illustrated example of FIG. 3, an example independent variable (causal) 302 (e.g., from supporting data 114) includes Adstock (y-axis) 304 over an independent variable time period (x-axis) 306. The example Adstock independent variable 302 may represent, for example, an indication of rating points, such as gross rating points (GRPs) indicative of how much of (e.g., what percentage of) an audience viewed or is expected to view and/or otherwise become exposed to a media vehicle. Marketing planners control a marketing driver modification (e.g., a tailored marketing campaign) via an amount of media invoked (e.g., purchased) for eventual exposure to the audience. In response to the marketing planner's manipulation of the independent variable, an example marketing driver exhibits a corresponding effect 307 (e.g., from supporting data 114).

In the illustrated example of FIG. 3, the effect 307 of the stimuli (represented by the independent variable 302) is shown as a dependent variable in the form of percent lift 308 (y-axis) over a dependent variable time period (x-axis) 310. In the example of FIG. 3, the independent variable time period 306 and the example dependent variable time period 310 exhibit the same time period values, but example methods, systems, apparatus and/or articles of manufacture disclosed herein are not limited thereto. For example, there may be a lag between the occurrence of the stimuli and the corresponding effect sufficient to make usage of a different timeframe useful. The example model 312 of FIG. 3 is represented as an equation 312. The example source model equation engine 202 of FIG. 2 identifies one or more parameters associated with the model 312 of interest (e.g., from one of models 108, 110, 112 and corresponding supporting data 108A, 110A, 112A, respectively). In the illustrated example of FIG. 3, the source model equation engine 202 identifies Beta 314 and Alpha 316 as parameters of the model 312.

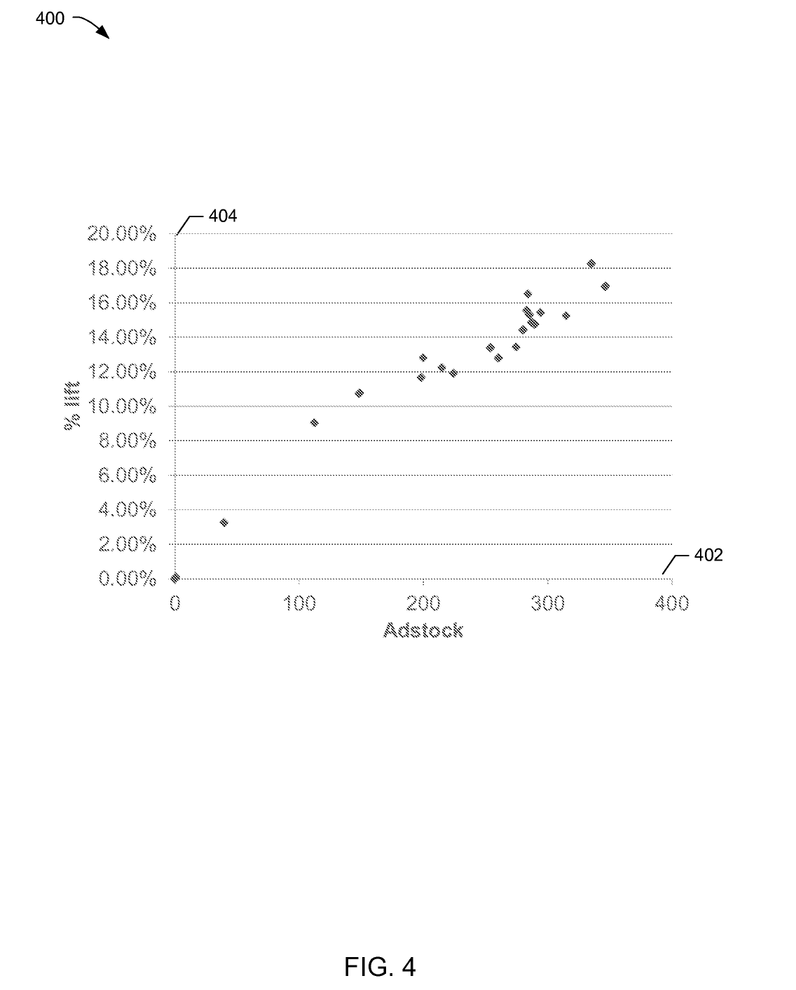

Returning to FIG. 2, the example scatter plot manager 208 builds a scatter plot by overlapping the example independent data 304 and dependent data 308. More specifically, the example scatter plot manager 208 builds a scatter plot 400 as shown in the illustrated example of FIG. 4. In the illustrated example of FIG. 4, the scatter plot 400 includes independent variable data in an x-axis 402, and dependent variable data in a y-axis 404. The example scatter plot 400 and corresponding x-axis variable data 402 and y-axis variable data 404 are employed by the example parameter estimator 210 to determine best fit parameters in view of the selected and/or otherwise retrieved model 102, such as model 312 from FIG. 3. Generally speaking, each model of interest produces a shape because, in the example case of marketing models, a volumetric decomposition represents a particular driver of a marketing campaign effort, such as television advertising. By plotting decomposed driver sales of a model of interest against one or more different causal values, data points will be produced by the functional form to reveal a corresponding shape.

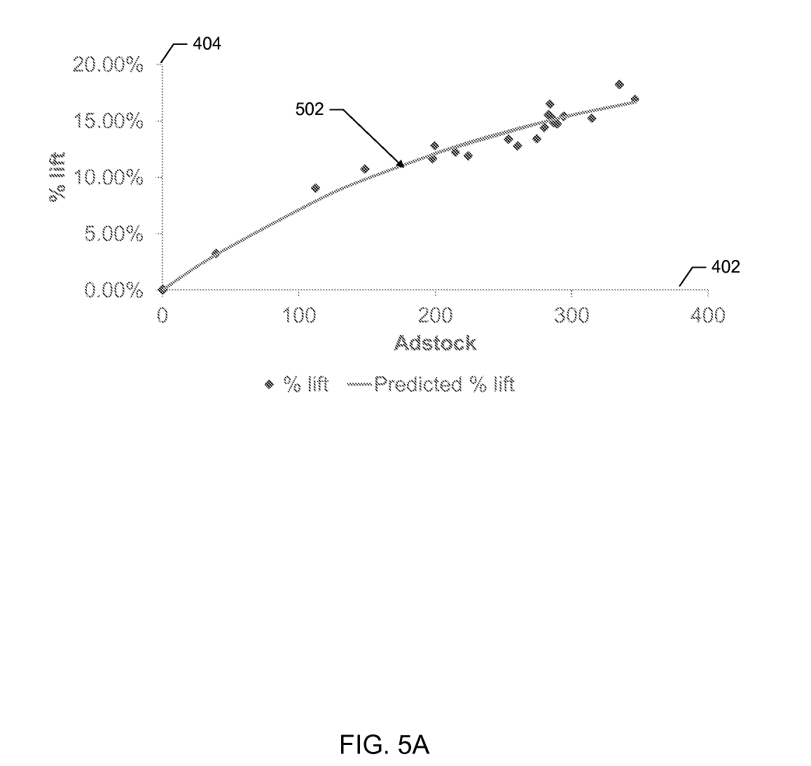

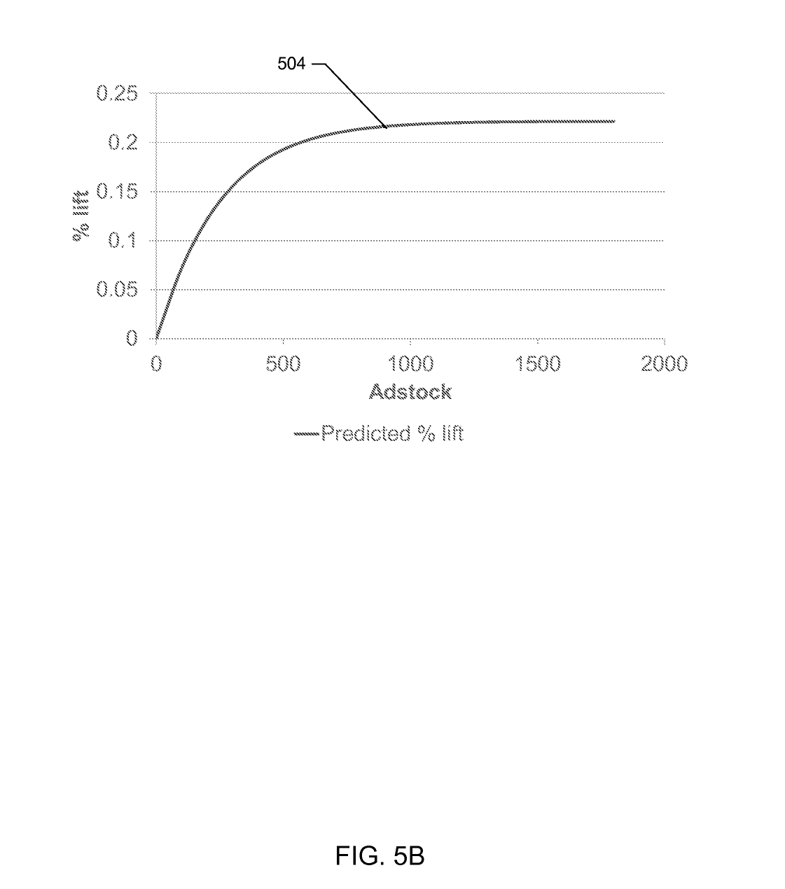

As shown in the illustrated example of FIG. 5A, the parameter estimator 210 estimates the parameters of the selected model 312 to determine best fit parameter values, fits the independent and dependent values, and generates a corresponding best fit curve 502. In other words, the parameter estimator 210 applies values from the independent variable and values from the dependent variable to the model 312. In the event that the original input data (e.g., an original range of independent variable values and/or an original range of dependent variable values) corresponding to the independent variable data 302 and the dependent variable data 307 include a limited range, the example extrapolator 212 generates an extrapolated best fit curve 504 using predicted values, as shown in FIG. 5B.

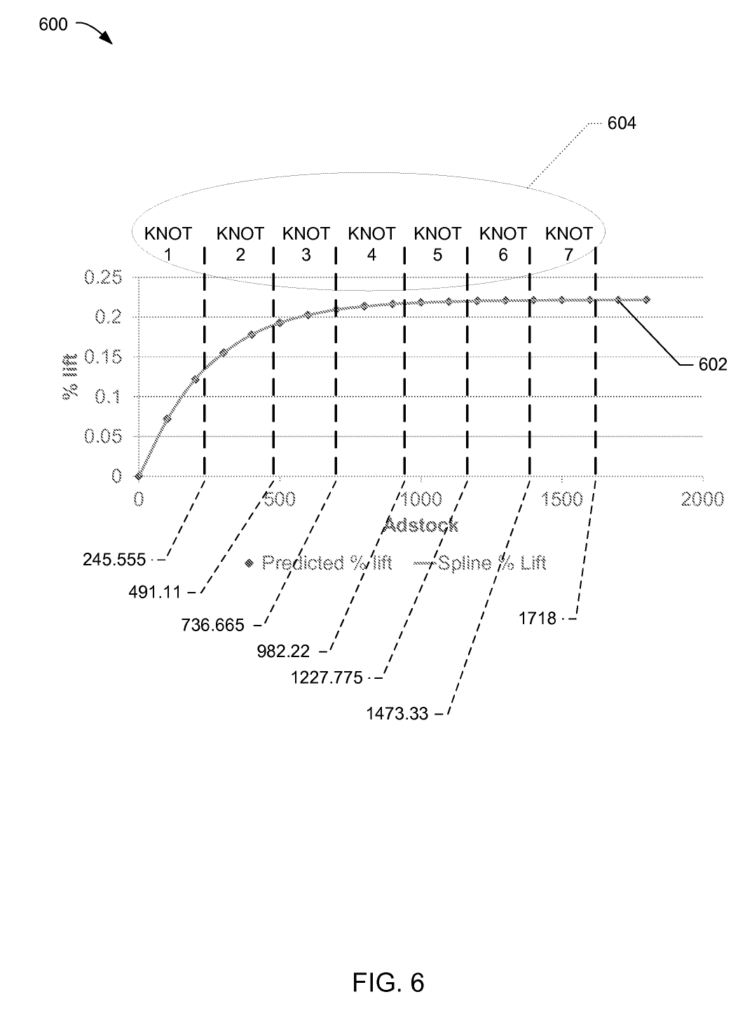

While the example model 312 and corresponding supporting data 114 reflect a unique model functional form (e.g., the unique model 312 of FIG. 3), such uniqueness requires programming and/or configuration efforts prior to application to a simulator, such as the example simulator 106 of FIG. 1. To reduce such efforts, the example spline engine 214 generates and/or otherwise estimates a uniform spline using the best fit curve 502 and/or the extrapolated best fit curve 504. FIG. 6 illustrates an example spline plot 600 that includes a spline curve 602 that matches the extrapolated best fit curve 504 of FIG. 5B. In the illustrated example of FIG. 6, the spline curve 602 approximates predicted percent lift from the extrapolated best fit curve 504 to form a plurality of polynomial functions corresponding to one or more knots 604. The one or more knots 604 represent locations of the spline curve 602 where the one or more polynomial functions join together. In the illustrated example of FIG. 6, seven (7) knots 604 are identified and/or otherwise calculated by the example spline engine 214. As such, the example spline engine 214 delineates and/or otherwise identifies one or more ranges of independent variable inputs to be used in a simulation with corresponding spline coefficient values. In other words, the example spline engine 214 generates polynomial coefficients and corresponding knot coordinates based on supporting data input values 114 to create a generic representation of the model that can be used by a simulator.

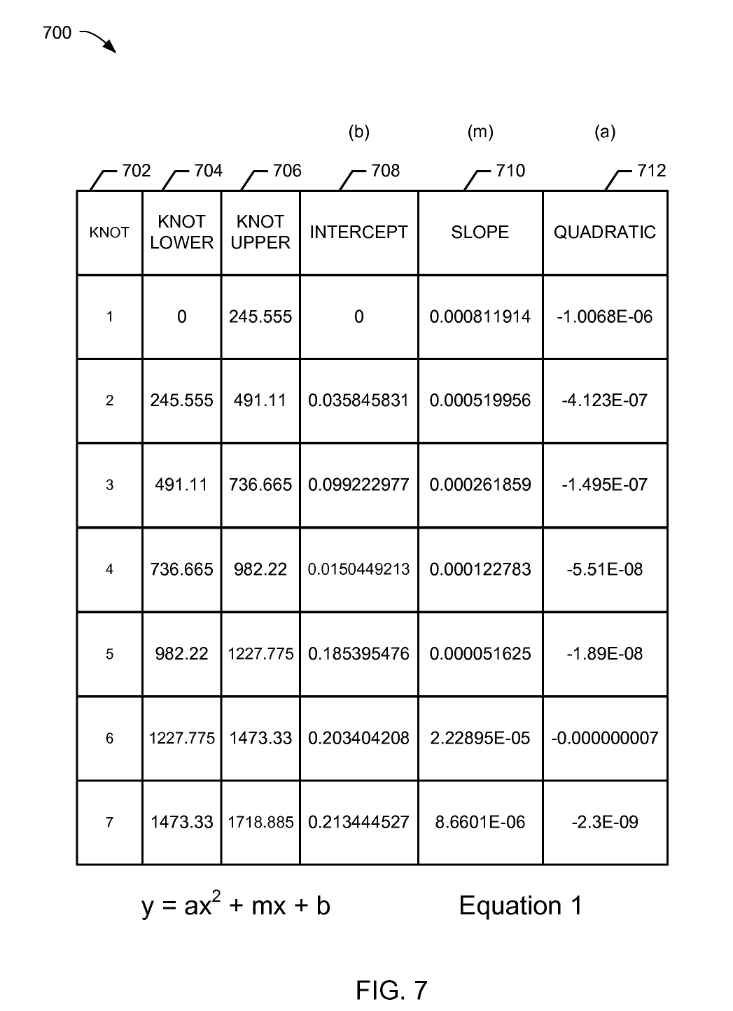

The example spline output formatter 216 of FIG. 2 generates an output format of the spline curve 602 for use in a simulator, such as the example simulator 106 of FIG. 1. In other words, the example spline output formatter 216 arranges and/or otherwise formats the spline coefficients to match input requirements of a simulator, such as the example simulator 106 of FIG. 1. FIG. 7 is a table 700 of example spline coefficients generated by the example spline engine 214. In the illustrated example of FIG. 7, the table 700 includes a knot column 702, a knot lower boundary column 704, a knot upper boundary column 706, an intercept column 708, a slope column 710 and a quadratic column 712. Unlike traditional approaches to performing one or more simulations of a model where a simulator is programmed to receive and/or otherwise accept the unique functional form for each model of interest, example methods, systems, apparatus and/or articles of manufacture disclosed herein format any model of interest as a plurality of spline coefficients and corresponding knots. In operation, the knot column 702 includes a plurality of knot range subsets associated with corresponding coefficient values. In the illustrated example of FIG. 7, seven (7) knot range subsets are shown (i.e., 1 through 7) that may be selected based on whether a simulated independent variable value of interest falls between the threshold values in the corresponding knot lower column 704 and the knot upper column 706. If the marketing planner wishes to simulate an input model of interest with alternate causal input(s), such as an example Adstock input of “264,” then the corresponding knot range employed by the example simulator 106 corresponds to knot range subset “2.”

In other words, the example Adstock input value of “264” (e.g., an indication of rating points, GRPs, etc.) resides between the knot lower column value “245.555” and the knot upper column value of “491.11,” which resides in row “2” of the knot range column 702. Corresponding spline coefficient values for row “2” (knot range subset “2”) are “0.035845831” for the intercept column 708, “0.000519956” for the slope column 710, and “−-4.123E-07” for the quadratic column 712. If the example spline curve 602 generated by the example spline engine 214 takes the form of example Equation 1, then the predicted percent lift in response to an Adstock input value of 264 is 14.1%.

y=ax²+mx+b Equation 1.

In the illustrated example of Equation 1, a represents the quadratic column value, m represents the slope column value, and b represents the intercept column value.

While an example manner of implementing the example model translation engine 104 has been illustrated in FIGS. 1-5A, 5B, 6 and 7, one or more of the elements, processes and/or devices illustrated in FIGS. 1-5A, 5B, 6 and 7 may be combined, divided, re-arranged, omitted, eliminated and/or implemented in any other way. Further, the example model translation engine 104, the example source model equation engine 202, the example source model causal data engine 204, the example source model lift data engine 206, the example scatter plot manager 208, the example parameter estimator 210, the example extrapolator 212, the example spline engine 214 and/or the example spline output formatter 216 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example model translation engine 104, the example source model equation engine 202, the example source model causal data engine 204, the example source model lift data engine 206, the example scatter plot manager 208, the example parameter estimator 210, the example extrapolator 212, the example spline engine 214 and/or the example spline output formatter 216 of FIG. 2 are hereby expressly defined to include a tangible computer readable medium such as a memory, DVD, CD, etc. storing the software and/or firmware. Further still, the example system 100 of FIGS. 1-5A, 5B, 6 and 7 may include one or more elements, processes and/or devices in addition to, or instead of, those illustrated in FIGS. 1-5A, 5B, 6 and 7, and/or may include more than one of any or all of the illustrated elements, processes and devices.

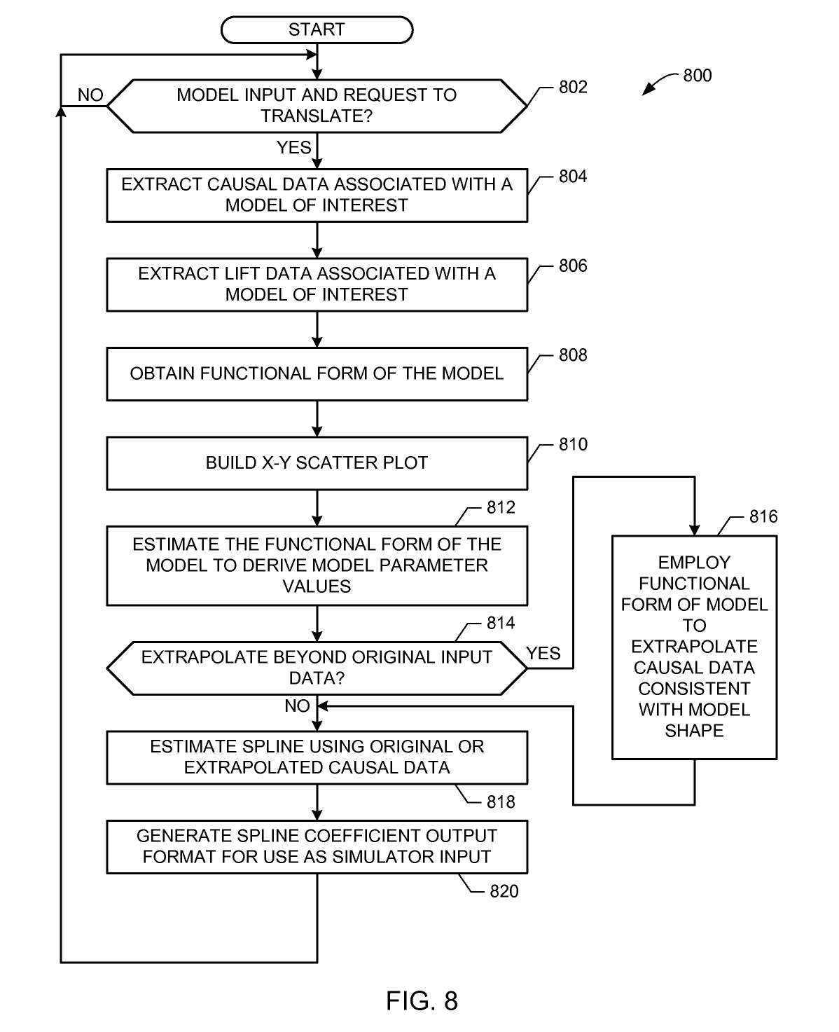

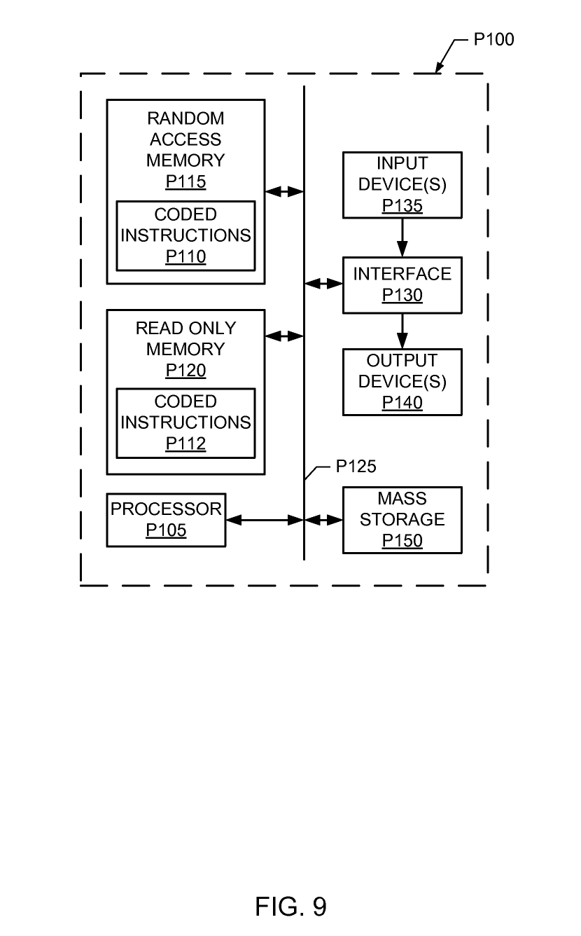

Flowcharts representative of example machine readable instructions for implementing the system 100 of FIGS. 1-5A, 5B, 6 and 7 and/or the example model translation engine 104 of FIGS. 1 and 2 are shown in FIG. 8. In these examples, the machine readable instructions comprise a program for execution by a processor such as the processor P105 shown in the example computer P100 discussed below in connection with FIG. 9. The program may be embodied in software stored on a tangible computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example program is described with reference to the flowcharts illustrated in FIG. 8, many other methods of implementing the example system 100 and/or the example model translation engine 104 may alternatively be used. For example, the order of execution of the blocks may be changed, and/or some of the blocks described may be changed, eliminated, or combined.

As mentioned above, the example processes of FIG. 8 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 8 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

The program 800 of FIG. 8 begins at block 802 where the example model translation engine 104 monitors for selection of or input of a model 102 of interest (e.g., model 108, model 110, model 112, etc.), corresponding supporting data 114 (e.g., supporting data 108A, supporting data 110A, supporting data 112A, etc.) and a request to perform translation of the model 102 of interest. If no such request, model 102, and/or supporting data 114 are received, retrieved and/or otherwise detected, the example program 800 continues to wait (block 802). Otherwise, in response to a request to translate a model 102 of interest, the example source model causal data engine 204 extracts causal data associated with the supporting data 114 (block 804), extracts lift data associated with the supporting data 114 (block 806), and extracts a functional form of the model 102 (block 808). As described above, the causal data (e.g., independent variable data) and the lift data (e.g., dependent variable data) may be received in any number of formats such as, but not limited to tabular data, text files, delimited character files and/or matrices.

The example scatter plot manager 208 builds a scatter plot of the supporting data 114 and assigns the independent data to x-axis coordinates and assigns the dependent data to y-axis coordinates (block 810). Using the functional form of the model 102 of interest (e.g., model equation 312 of FIG. 3), extracted independent data (e.g., Adstock data 302 of FIG. 3) and extracted dependent data (e.g., percent lift data 307 of FIG. 3), the example parameter estimator 210 estimates the functional form of the model 102 of interest to derive model parameter values that best fit the supplied independent and dependent data (block 812).

In the event that the supplied (original) input independent and dependent data does not include a sufficient range of interest (block 814), the example extrapolator 212 employs the estimated model parameters from the example parameter estimator 210 to extrapolate beyond the original data range (block 816). In either case where extrapolated data is desired or not desired (block 814), the example spline engine 214 estimates a spline using the original data or extrapolated data (block 818). The example spline generated by the example spline engine 214 attempts to track as closely as possible to the curve generated by the original model 102. Because the spline is a plurality of piecewise polynomial functions, one or more knots are identified by the example spline engine 214 (e.g., each knot corresponding to a respective one of the polynomial functions). The knots end at locations of independent data of a spline where two polynomial curve portions of the curve meet. Thus, the ends of the knots represent corresponding transitions between polynomial functions. The example spline output formatter 216 arranges the spline coefficients into knot range subsets and generates a uniform spline output format (block 820) to be used as input to a simulator, such as the example simulator 106 of FIG. 1.

FIG. 9 is a block diagram of an example processing platform P100 capable of executing the instructions of FIG. 8 to implement the example system 100 and/or model translation engine 104 of FIGS. 1-5A, 5B, 6 and 7. The processor platform P100 can be, for example, a server, a personal computer, or any other type of computing device.

The processor platform P100 of the instant example includes a processor P105. For example, the processor P105 can be implemented by one or more Intel® microprocessors. Of course, other processors from other families are also appropriate.

The processor P105 is in communication with a main memory including a volatile memory P115 and a non-volatile memory P120 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory P120 may be implemented by flash memory and/or any other desired type of memory device. Access to the main memory P115, P120 is typically controlled by a memory controller.

The processor platform P100 also includes an interface circuit P130. The interface circuit P130 may be implemented by any type of past, present or future interface standard, such as an Ethernet interface, a universal serial bus (USB), and/or a PCI express interface.

One or more input devices P135 are connected to the interface circuit P130. The input device(s) P135 permit a user to enter data and commands into the processor P105. The input device(s) can be implemented by, for example, a keyboard, a mouse, a touchscreen, a track-pad, a trackball, isopoint and/or a voice recognition system.

One or more output devices P140 are also connected to the interface circuit P130. The output devices P140 can be implemented, for example, by display devices (e.g., a liquid crystal display, and/or a cathode ray tube display (CRT)). The interface circuit P130, thus, typically includes a graphics driver card.

The interface circuit P130 also includes a communication device, such as a modem or network interface card to facilitate exchange of data with external computers via a network (e.g., an Ethernet connection, a digital subscriber line (DSL), a telephone line, coaxial cable, a cellular telephone system, etc.).

The processor platform P100 also includes one or more mass storage devices P150 for storing software and data. Examples of such mass storage devices P150 include floppy disk drives, hard drive disks, compact disk drives and digital versatile disk (DVD) drives.

The coded instructions of FIG. 8 may be stored in the mass storage device P150, in the volatile memory P110, in the non-volatile memory P112, and/or on a removable storage medium such as a CD or DVD.

From the foregoing, it will be appreciated that disclosed methods, apparatus, systems and/or articles of manufacture allow a reduction in programming and/or model configuration resources when attempting to simulate a model of interest with alternate independent variable input values. Rather than require customization and/or programming of a simulator in view of the unique functional form of the model of interest, methods, systems, apparatus and/or articles of manufacture disclosed herein translate the model of interest into a form normalized and compatible with the simulator based on a plurality of piecewise polynomials (i.e., translate the model into a spline). While example methods, apparatus, systems and/or articles of manufacture disclosed herein include one or more examples related to marketing, the teachings of this disclosure are not limited thereto.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to translate a model to a spline, comprising:
applying an independent variable and a dependent variable to the model and estimating a value for a model parameter;
generating predicted best fit data points based on the model parameter, values associated with the independent variable, and values associated with the dependent variable;
estimating coefficients based on the best fit data points; and
generating a spline comprising a plurality of polynomial functions based on the coefficients.

2. A method as described in claim 1, wherein the model comprises a marketing mix model.

3. A method as described in claim 2, wherein the marketing mix model comprises a volumetric decomposition based on a marketing driver.

4. A method as described in claim 1, wherein the independent variable is associated with a marketing driver.

5. A method as described in claim 4, further comprising utilizing gross rating points as a unit of measure for the market driver.

6. A method as described in claim 4, wherein the marketing driver comprises at least one of television advertisements, newspaper advertisements, coupons, or in-store promotions.

7. A method as described in claim 1, wherein generating the spline further comprises generating the plurality of polynomial equations to respectively fit a plurality of knot range subsets.

8. A method as described in claim 1, further comprising extrapolating the predicted best fit data points beyond an original range associated with the independent variable and the dependent variable.

9. A method as described in claim 1, further comprising formatting the coefficients to match input requirements of a simulator.

10. A method as described in claim 9, further comprising associating subsets of the coefficients with corresponding ones of a plurality of knot range subsets.

11. An apparatus to translate a model to a spline, comprising:
a source model lift data engine to apply an independent variable to the model, and a source model causal data engine to apply a dependent variable to the model;
a parameter estimator to estimate a value for a model parameter, and to generate predicted best fit data points based on the model parameter, based on values associated with the independent variable, and based on values associated with the dependent variable; and
a spline engine to estimate coefficients based on the best fit data points, and to generate a spline comprising a plurality of polynomial functions based on the coefficients.

12. An apparatus as described in claim 11, further comprising a source model equation engine to identify the model parameter associated with the model.

13. An apparatus as described in claim 12, wherein the source model equation engine receives a functional form of the model.

14. An apparatus as described in claim 11, wherein the spline engine generates the plurality of polynomial functions to respectively fit a plurality of knot range subsets.

15. An apparatus as described in claim 11, further comprising an extrapolator to extrapolate the predicted best fit data points beyond an original range associated with the independent variable and the dependent variable.

16. An apparatus as described in claim 11, further comprising a spline output formatter to format the coefficients to match input requirements of a simulator.

17. A tangible machine accessible medium having instructions stored thereon that, when executed, cause a machine to, at least:
apply an independent variable and a dependent variable to the model and estimating a value for a model parameter;
generate predicted best fit data points based on the model parameter, values associated with the independent variable, and values associated with the dependent variable;
estimate coefficients based on the best fit data points; and
generate a spline comprising a plurality of polynomial functions based on the coefficients.

18. A tangible machine accessible medium as described in claim 17 having instructions stored thereon that, when executed, cause a machine to generate a spline for a marketing mix model.

19. A tangible machine accessible medium as described in claim 18 having instructions stored thereon that, when executed, cause a machine to process the marketing mix model with a volumetric decomposition based on a marketing driver.

20. A tangible machine accessible medium as described in claim 17 having instructions stored thereon that, when executed, cause a machine to utilize gross rating points as a unit of measure for a market driver.

21. A tangible machine accessible medium as described in claim 17 having instructions stored thereon that, when executed, cause a machine to generate the plurality of polynomial equations to respectively fit a plurality of knot range subsets.

22. A tangible machine accessible medium as described in claim 17 having instructions stored thereon that, when executed, cause a machine to extrapolate the predicted best fit data points beyond an original range associated with the independent variable and the dependent variable.

23. A tangible machine accessible medium as described in claim 17 having instructions stored thereon that, when executed, cause a machine to format the coefficients to match input requirements of a simulator.

24. A tangible machine accessible medium as described in claim 23 having instructions stored thereon that, when executed, cause a machine to associate subsets of the coefficients with corresponding ones of a plurality of knot range subsets.
